(19) United States
(12) Patent Application Publication
(10) Pub. No.: US 2025/0330054 A1
(43) Pub. Date: Oct. 23, 2025

(54) ROTOR FOR ELECTRIC MOTOR

(71) Applicant: FANUC CORPORATION, Minamitsuru-gun, Yamanashi (JP)

(72) Inventor: Yusuke IMAIZUMI, Minamitsuru-gun, Yamanashi (JP)

(73) Assignee: FANUC CORPORATION, Minamitsuru-gun, Yamanashi (JP)

(21) Appl. No.: 18/866,288

(22) PCT Filed: Jul. 4, 2022
(86) PCT No.: PCT/JP2022/026579

§ 371 Date: Nov. 15, 2024

(51) Int. Cl. H02K 1/28

(52) U.S. Cl. CPC H02K 1/28

(57) ABSTRACT

A rotor for an electric motor according to the present disclosure is for an electric motor that provides power to rotary equipment, the rotor comprising: a rotor body which is rotatably disposed inside a stator and has a recess on one end surface in the axial direction; an adaptor which is inserted into the recess and thereby attached to the rotor body, and into which the shaft of the rotary equipment is non-rotatably inserted; and a fixing unit that detachably fixes the adaptor to the rotor body.

### TECHNICAL FIELD

The present invention relates to a rotor for an electric motor, and in particular, to a rotor into which a shaft part of a rotary device powered by the electric motor is inserted.

### BACKGROUND ART

Patent Document 1 below discloses a configuration in which a protrusion formed on a rotating shaft of a motor is engaged with a groove part formed on a central shaft of a cutting blade roller. Therefore, in the invention of Patent Document 1, the rotational force of the rotating shaft of the motor is transmitted to the cutting blade roller, so that the cutting blade roller can be rotated.

As a configuration in which a rotary device such as the cutting blade roller and a motor are engaged with each other, an engagement configuration as shown in FIG. 7 is conventionally known. In this engagement configuration, a shaft 102 of a rotor 101 rotatably disposed inside a stator 100 is non-rotatably inserted into an insertion hole 105 in a shaft part 104 of a rotary device 103. To non-rotatably insert the shaft 102 of the rotor 101 into the insertion hole 105 in the shaft part 104 of the rotary device 103, for example, a tapered shaft 102 is inserted into the insertion hole 105 to be tapered-coupled, or a shaft 102 having spline teeth is inserted into an insertion hole 105 having spline teeth to be spline-coupled.

### CITATION LIST

### Patent Document

Patent Document 1: Japanese Unexamined Patent Application, Publication No. 2004-357542

### DISCLOSURE OF THE INVENTION

### Problems to be Solved by the Invention

In the case of tapered coupling or spline coupling, when the configuration of the insertion hole in the rotary device is different, the configuration of the shaft is also different. Therefore, a different motor rotor is required for each rotary device having a different configuration of the insertion hole. In this case, it is necessary to prepare a plurality of motor rotors, which increases the cost of the motor. In the case of spline coupling, since the spline teeth are subject to wear due to minute vibration or the like, it is necessary to replace the motor every predetermined period of time, which requires labor and cost. Therefore, there is a demand for a rotor for an electric motor that can be simply and inexpensively adapted to rotary devices having different configurations.

### Means for Solving the Problems

One aspect of the present disclosure is a rotor for an electric motor for powering a rotary device. The rotor includes a rotor body rotatably disposed inside a stator and including a recess on one end surface thereof in an axial direction; an adapter that is attached to the rotor body in a state of being inserted into the recess, and into which a shaft part of the rotary device is non-rotatably inserted; and a fixing part configured to detachably fix the adapter to the rotor body.

### Effects of the Invention

According to the aspect, it is possible to provide a rotor for an electric motor that can be simply and inexpensively adapted to rotary devices having different configurations.

### BRIEF DESCRIPTION OF THE DRAWINGS

FIG. 1 is a left side view showing a use state of a rotor for an electric motor according to a first embodiment of the present invention, with part of the view shown in cross section;

FIG. 2 is a left side view showing, in an exploded state, a use state of the rotor for the electric motor according to the first embodiment of the present invention, with part of the exploded state shown in cross section;

FIG. 3 is a front elevation view showing the rotor for the electric motor according to the first embodiment of the present invention;

FIG. 4 is a left side view showing a use state of a rotor for an electric motor according to a second embodiment of the present invention, with part of the view shown in cross section;

FIG. 5 is a left side view showing a use state of a rotor for an electric motor according to a first modification of the first embodiment, with part of the view shown in cross section;

FIG. 6 is a left side view showing a use state of a rotor for an electric motor according to a second modification of the first embodiment, with part of the view shown in cross section; and

FIG. 7 is a longitudinal sectional view showing a use state of a conventional rotor for an electric motor.

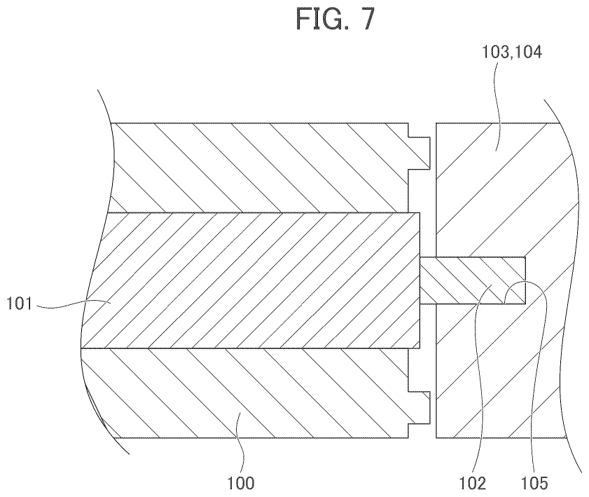

### PREFERRED MODE FOR CARRYING OUT THE INVENTION

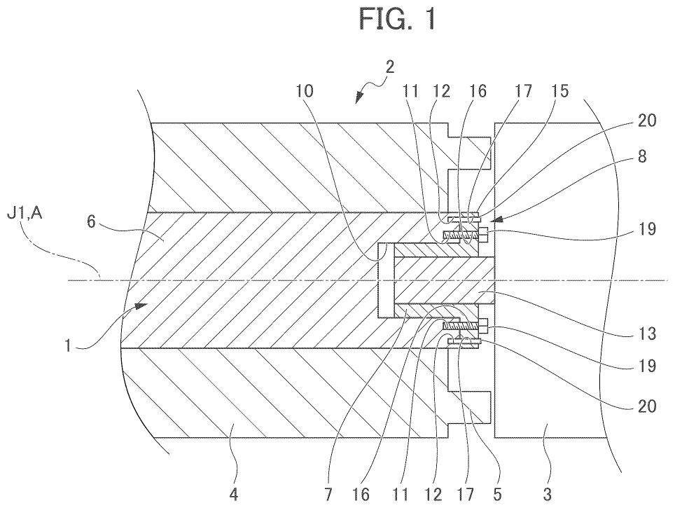

A rotor for an electric motor according to one aspect of the present disclosure will now be described with reference to the drawings. With reference to FIGS. 1 to 3, an electric motor 2 including a rotor 1 according to a first embodiment will be described. The electric motor 2 powers a rotary device 3, and is, for example, a servo motor. The electric motor 2 includes a stator 4, a rotor 1, and a housing (not shown). Hereinafter, an axial direction J1 is defined as the front-rear direction. At this time, one end side in the axial direction J1 is defined as the front side, and the other end side in the axial direction J1 is defined as the rear side.

The stator 4 is held in the housing so that the axial direction J1 is along the front-rear direction. The stator 4 includes a contact part 5, with which the rotary device 3 contacts, on one end surface thereof in the axial direction J1. The contact part 5 has an annular shape protruding forward from the front surface of the stator 4. A coil (not shown) is wound around the stator 4.

The rotor 1 is provided inside the stator 4. The rotor 1 includes a rotor body 6 rotatably disposed inside the stator 4, an adapter 7 detachably attached to the rotor body 6, and a fixing part 8 detachably fixing the adapter 7 to the rotor body 6.

The rotor body 6 is disposed inside the stator 4 so that the axial direction J1 is along the front-rear direction. The rotor body 6 receives a force from a rotating magnetic field generated by a voltage applied to the coil of the stator 4. This allows the rotor body 6 to rotate about its axis A. In this way, the rotor body 6 is disposed inside the stator 4 so as to be rotatable about its axis A. The rotor body 6 includes a recess 10 on a front surface 9 that is one end surface thereof in the axial direction J1. The recess 10 has a circular shape in front view or a polygonal shape in front view, and opens forward. The front surface 9 of the rotor body 6 is provided with a plurality of screw holes 11 opening forward. The plurality of screw holes 11 are annularly arranged on an imaginary circle centered on the axis A. A female screw is formed on the inner peripheral surface of each screw hole 11. The front surface 9 of the rotor body 6 is provided with a plurality of insertion holes 12 opening forward. The plurality of insertion holes 12 are disposed on an imaginary circle centered on the axis A. In the present embodiment, two insertion holes 12 are arranged at positions sandwiching the axis A.

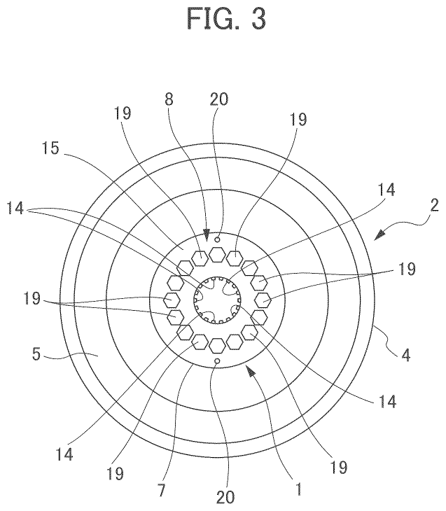

The adapter 7 is made of, for example, iron and has a cylindrical shape into which a shaft part 13 of the rotary device 3 is inserted. The adapter 7 has a cylindrical shape that opens in the axial direction J1. As shown in FIG. 3, a plurality of spline teeth 14 protruding radially inward of the adapter 7 are provided on the inner peripheral surface of the adapter 7. The plurality of spline teeth 14 are annularly arranged. The adapter 7 includes a plate-shaped flange 15 extending radially outward of the adapter 7 at one end part thereof in the axial direction J1. The flange 15 is provided with a plurality of through holes 16 penetrating in the axial direction J1. The plurality of through holes 16 are annularly arranged on an imaginary circle centered on the axis A. The flange 15 is provided with a plurality of passing holes 17 penetrating in the axial direction J1. The plurality of passing holes 17 are arranged on an imaginary circle centered on the axis A. In the present embodiment, two passing holes 17 are arranged at positions sandwiching the axis A.

The shaft part 13 of the rotary device 3 is provided with spline teeth 18 that mesh with the spline teeth 14 of the adapter 7. The shaft part 13 of the rotary device 3 has a rod shape with a circular cross section. A plurality of spline teeth 18 protruding radially outward of the shaft part 13 are provided on the outer peripheral surface of the shaft part 13. The plurality of spline teeth 18 are annularly arranged.

The fixing part 8 includes screw members 19 to be screwed into the rotor body 6 via the adapter 7, and pins 20 to be inserted into the rotor body 6 via the adapter 7. In the first embodiment, the screw member 19 is a bolt. The pin 20 has a rod shape with a circular cross section.

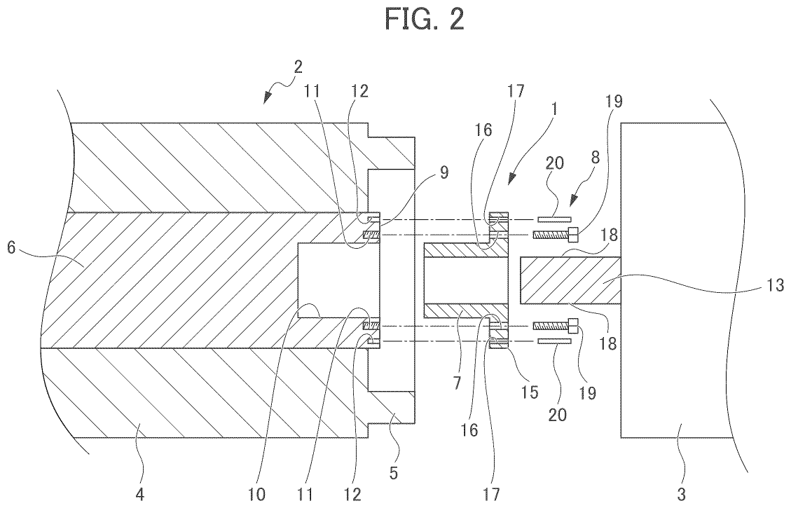

As shown in FIGS. 1 and 2, to attach the adapter 7 to the rotor body 6, the adapter 7 is inserted into the recess 10 such that the flange 15 contacts the front surface 9 of the rotor body 6. To fix the adapter 7 to the rotor body 6 in this state, the screw member 19 is screwed into the screw hole 11 in the rotor body 6 through the through hole 16 in the flange 15, and the pin 20 is inserted into the insertion hole 12 in the rotor body 6 through the passing hole 17 in the flange 15. Thus, the adapter 7 is non-rotatably and detachably attached to the rotor body 6 in a state of being inserted into the recess 10 of the rotor body 6. In a state where the adapter 7 is attached to the rotor body 6, the adapter 7 and the rotor body 6 are disposed on the same axis. In the first embodiment, the diameter of the insertion hole 12 into which the pin 20 is inserted is larger than the diameter of the passing hole 17 through which the pin 20 passes.

The electric motor 2 and the rotary device 3 thus configured are connected to each other by engaging the rotor 1 of the electric motor 2 with the shaft part 13 of the rotary device 3. In the first embodiment, the shaft part 13 is inserted into the adapter 7 such that the spline teeth 14 of the adapter 7 and the spline teeth 18 of the shaft part 13 mesh with each other, whereby the rotor 1 of the electric motor 2 and the shaft part 13 of the rotary device 3 are engaged with each other. That is, the rotor 1 of the electric motor 2 and the shaft part 13 of the rotary device 3 are spline-coupled to each other. Therefore, the shaft part 13 of the rotary device 3 is non-rotatably inserted into the adapter 7 and rotates together with the rotor body 6. Since the electric motor 2 and the rotary device 3 are connected to each other in this manner, the rotor 1 of the electric motor 2 rotates to power the rotary device 3. In the first embodiment, the rotary device 3 contacts the contact part 5 of the stator 4, preventing the shaft part 13 from being inserted into the adapter 7 more than necessary.

In the case of the first embodiment, the shaft part 13 of the rotary device 3 is engaged with the adapter 7 detachably attached to the rotor body 6. Because of this configuration, by preparing the adapter 7 corresponding to each of the shaft parts 13 with different configurations, a plurality of rotary devices 3 each including a shaft part 13 with a different configuration, can be connected to the electric motor 2 simply by replacing the adapter 7. Therefore, the rotor 1 of the first embodiment can be simply and inexpensively adapted to the rotary device 3 including the shaft parts 13 with different configurations.

In the case of the first embodiment, when the electric motor 2 transmits power to the rotary device 3, the shaft part 13 of the rotary device 3 contacts the adapter 7. Therefore, according to the first embodiment, since it is the adapter 7 that wears due to contact with the shaft part 13, only the adapter 7 needs to be replaced.

In the case of the first embodiment, the fixing part 8 is a screw member 19 screwed into the rotor body 6 via the adapter 7. Therefore, according to the first embodiment, the adapter 7 can be easily attached to and detached from the rotor body 6. In the case of the first embodiment, the adapter 7 is fixed to the rotor body 6 with a plurality of screw members 19. Therefore, according to the first embodiment, when the electric motor 2 transmits power to the rotary device 3, the adapter 7 can be prevented from rotating with respect to the rotor body 6.

In the case of the first embodiment, the fixing part 8 is the pin 20 inserted into the rotor body 6 via the adapter 7. Therefore, according to the first embodiment, the adapter 7 can be positioned with respect to the rotor body 6 by inserting the pin 20 into the rotor body 6. That is, the screw hole 11 in the rotor body 6 and the through hole 16 in the adapter 7 can be easily positioned. In the case of the first embodiment, the adapter 7 is fixed to the rotor body 6 with a plurality of pins 20. Therefore, according to the first embodiment, when the electric motor 2 transmits power to the rotary device 3, the adapter 7 can be prevented from rotating with respect to the rotor body 6.

In the case of the first embodiment, the diameter of the insertion hole 12 is larger than the diameter of the passing hole 17. Because of this configuration, when the adapter 7 is removed from the rotor body 6, the pin 20 does not remain in the rotor body 6. Therefore, according to the first embodiment, the maintainability of the rotor 1 can be improved.

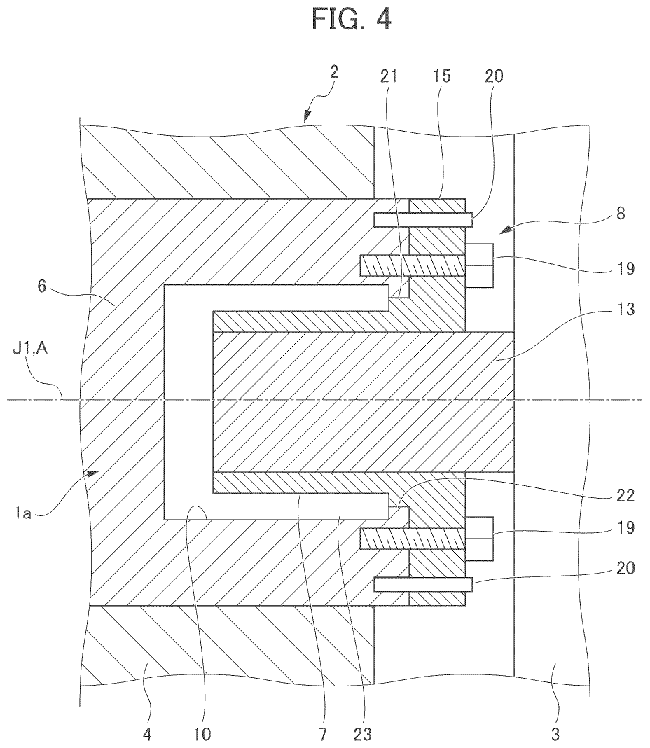

Next, a rotor according to a second embodiment of the present invention will be described with reference to FIG. 4. Note that components having the same reference numerals as those used in the first embodiment have the same operation, and thus descriptions thereof may be omitted below. A rotor 1a of the second embodiment differs from that of the first embodiment in the configurations of the adapter 7 and the rotor body 6.

The adapter 7 includes an annular spigot part 21 on its outer peripheral surface. The spigot part 21 has an annular shape protruding radially outward of the adapter 7 from the outer peripheral surface of the adapter 7 and protruding toward the other end side of the adapter 7 in the axial direction J1 from the flange 15. The recess 10 of the rotor body 6 includes an annular fitted part 22, into which the spigot part 21 is inserted, at one end part of the inner peripheral surface thereof in the axial direction J1. The fitted part 22 has an annular shape protruding radially inward of the recess 10 from the inner peripheral surface of the recess 10.

As shown in FIG. 4, the spigot part 21 of the adapter 7 is inserted into the fitted part 22 of the recess 10 in a state where the adapter 7 is attached to the rotor body 6. In a state where the spigot part 21 of the adapter 7 is inserted into the fitted part 22 of the recess 10, the outer peripheral surface of the spigot part 21 of the adapter 7 is in contact with the inner peripheral surface of the fitted part 22 of the recess 10. In the state where the outer peripheral surface of the spigot part 21 and the inner peripheral surface of the fitted part 22 are in contact with each other, a cylindrical gap 23 is formed between the outer peripheral surface of the adapter 7 and the inner peripheral surface of the recess 10.

Because of this configuration, the spigot part 21 is inserted into the fitted part 22, so that the adapter 7 can be positioned with respect to the rotor body 6. Therefore, according to the rotor 1a of the second embodiment, the machining area of the part used for positioning can be reduced compared to the case where the adapter 7 is positioned with respect to the rotor body 6 by contacting the outer peripheral surface of the adapter 7 with the inner peripheral surface of the recess 10. Therefore, the rotor 1a of the second embodiment can reduce the cost of machining. In the case of the second embodiment, the fitted part 22 is provided in the opening of the recess 10. Therefore, according to the rotor 1a of the second embodiment, the ease of attaching and detaching the adapter 7 to and from the rotor body 6 can be improved.

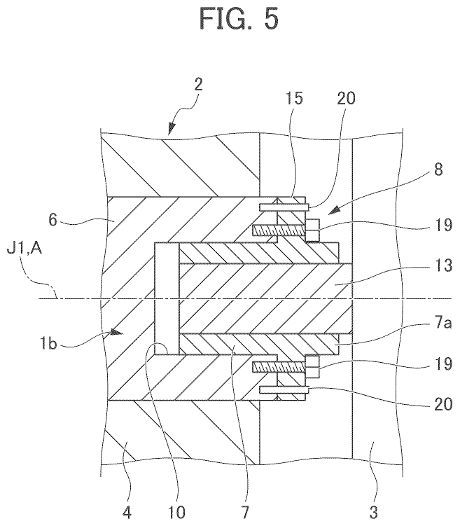

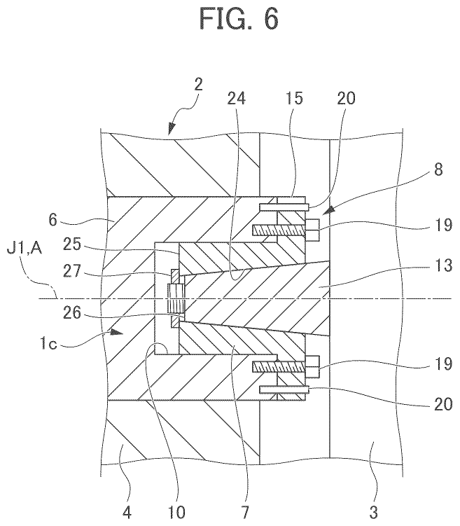

Next, modifications of the rotor of the present invention will be described with reference to FIGS. 5 and 6. Note that components having the same reference numerals as those used in the first embodiment have the same operation, and thus descriptions thereof may be omitted below.

As shown in FIG. 5, a rotor 1b of a first modification differs from that of the first embodiment in the configuration of the adapter 7. The adapter 7 includes the flange 15 on one end side in the axial direction J1 with respect to a central part in the axial direction J1. Therefore, in the first modification, one end part 7a of the cylindrical part of the adapter 7 in the axial direction J1 protrudes from the flange 15. The length of the adapter 7 of the first modification in the axial direction J1 is preferably longer than the length of the adapter 7 of the first embodiment in the axial direction J1. In this case, the rotor 1b can more reliably prevent misalignment of the shaft center of the shaft part 13 of the rotary device 3. In addition, since a sufficient contact area can be ensured between the adapter 7 and the shaft part 13 of the rotary device 3 and the surface pressure can be reduced, a larger rotational force can be transmitted.

As shown in FIG. 6, a rotor 1c of a second modification differs from that of the first embodiment in the configuration of the adapter 7. In the second modification, the distal end part of the shaft part 13 of the rotary device 3 is tapered so as to have a smaller diameter toward the other end side in the axial direction J1. Therefore, an inner hole 24 in the adapter 7 is tapered so as to decrease in diameter toward the other end side in the axial direction J1. Because of this configuration, the tapered distal end part of the shaft part 13 is inserted into the inner hole 24 in the adapter 7, whereby the shaft part 13 of the rotary device 3 is tapered-coupled to the adapter 7. In the present modification, a nut member 27 is screwed to the male screw part provided at the distal end part of the shaft part 13. The shaft part 13 of the rotary device 3 and the inner hole 24 in the adapter 7 are fixed to each other by the frictional force generated by the tightening of the nut member 27, so that an end surface 25 of the adapter 7 protrudes with respect to an end surface 26 of the shaft part 13.

It should be noted that the present invention is not limited to the above-described embodiments and the above-described modifications, and modifications and improvements within a range in which the object of the present invention can be achieved are included in the present invention.

For example, the adapter 7 is engaged with the shaft part 13 of the rotary device 3 by the spline coupling of the first embodiment or the tapered coupling of the second modification, but the present invention is not limited to this and it is only required that the adapter 7 is not rotatable with respect to the shaft part of the rotary device.

For example, a spigot part may be provided in each of the rotor 1b of the first modification and the rotor 1c of the second modification. In this case, a fitted part into which the spigot part is inserted is provided on the inner peripheral surface of the recess 10.

### EXPLANATION OF REFERENCE NUMERALS

1 rotor
2 electric motor
3 rotary device
4 stator
6 rotor body
7 adapter
8 fixing part
9 one end surface
10 recess
12 insertion hole
13 shaft part
17 passing hole
19 screw member
20 pin
21 spigot part
22 fitted part

1. A rotor for an electric motor for powering a rotary device, the rotor comprising:
a rotor body rotatably disposed inside a stator and comprising a recess on one end surface thereof in an axial direction;
an adapter that is attached to the rotor body in a state of being inserted into the recess, and into which a shaft part of the rotary device is non-rotatably inserted; and
a fixing part configured to detachably fix the adapter to the rotor body.

2. The rotor for an electric motor according to claim 1, wherein the fixing part comprises a screw member that is screwed into the rotor body via the adapter.

3. The rotor for an electric motor according to claim 2, wherein the fixing part comprises a pin inserted into an insertion hole in the rotor body through a passing hole in the adapter.

4. The rotor for an electric motor according to claim 3, wherein the insertion hole has a diameter larger than a diameter of the passing hole.

5. The rotor for an electric motor according to claim 1,
wherein the adapter has a cylindrical shape into which the shaft part is inserted, and comprises an annular spigot part protruding radially outward of the adapter on an outer peripheral surface thereof, and
wherein the recess comprises, at one end part of an inner peripheral surface thereof in the axial direction, an annular fitted part into which the spigot part is inserted and which protrudes radially inward of the recess.
